(19) United States
(12) Patent Application Publication
(10) Pub. No.: US 2011/0310523 A1
(43) Pub. Date: Dec. 22, 2011

(54) ELECTRICAL APPARATUS WITH ELECTROSTATIC SHIELD

(75) Inventors: Per-Olof Hedblad, Ludvika (SE); Dong Wu, Ludvika (SE)

(73) Assignee: ABB TECHNOLOGY AG, Zurich (CH)

(21) Appl. No.: 13/202,171

(22) PCT Filed: Feb. 20, 2009
(86) PCT No.: PCT/EP09/52070

§ 371 Date: Sep. 7, 2011

(51) Int. Cl. H05F 3/00

(52) U.S. Cl. 361/212

(57) ABSTRACT

An electrical apparatus, which is preferrably operated at voltages above 1 kV, comprises an electrostatic shield to reduce the electrical field strength outside of the apparatus. Advantageoulsy, the electrostatic shield is at least in part formed by a dielectric enclosure containing water.

The invention is related to an electrical apparatus, preferrably an apparatus operated at voltages above 1 kV, i.e. at medium voltage levels approximately between 1 kV and 50 kV or at high voltage levels above 50 kV, where the apparatus comprises an electrostatic shield.

Electrostatic shields are used in electrical apparatuses to affect the distribution of the electrical field around the apparatus in a desired way, such as by reducing the field strength in specific areas or by simply changing the spatial distribution of the field.

Such an electrical apparatus can for example be a power transformer, a motor, a generator, electrical switchgear, a reactor inductor or a power electronics device, such as a power converter, particularly a converter valve stack as part of the power converter.

For all these different types of apparatuses it is known in the art to use one or several electrostatic shields which are made of a conductive material, usually metal, in order to attenuate an electrical field produced by the electrical apparatus, thereby protecting the usually air-filled surrounding of the apparatus by reducing the probability of a dielectric breakdown in that surrounding via an increase of the breakdown or flashover voltage in that surrounding.

One example of an electrical apparatus with an electrostatic shield is given in WO2007/149023A1, where a high voltage power converter is described which comprises converter valves arranged in form of a column, i.e. in form of a valve stack. The column is surrounded by pipes filled with a coolant liquid used for cooling the converter, where the pipes are partly made of plastic, partly of metal, In the areas where the pipes are made of plastic, metallic screens are arranged at the outer surface of the pipes for electrostatic shielding. In the areas where the pipes are made of metal, the pipes take over the function of an electric field shielding screen. In WO2007/149023A1, the pipes are made of metal wherever it is possible in order to reduce the number of additional metallic screens. Only at certain contact points, where a connection is made between the pipes and coolant blocks which in turn are in physical contact with power semiconductor devices of the converter valves, the pipes are made of an electrically insulating material. This is necessary since different voltage levels exist between these contact points, which would result in a current flow inside the metal pipes if no isolation was provided.

Electrical apparatuses become usually more complicated and costly with increasing voltage level at which they are operated at. It is therefore an ongoing attempt to reduce their costs and simplify their design and construction.

Accordingly, it is an object of the invention to propose an electrical apparatus of the kind described above with a simplified and thereby less costly design.

This object is achieved by an electrical apparatus according to claim 1.

In general, water with a low concentration of minerals and thereby ions and in particular purified or deionized water is known as a dielectric. Since the resistivity of purified water is very low it is even used as an insulator.

The invention now is based on the unexpected finding by the inventors that water, even low ionized or purified water, contained in a dielectric enclosure, can affect and improve the electrostatic field strength distribution in its surrounding area sufficiently enough to be successfully applied as an electrostatic shield. This is unexpected since, as in WO2007/149023A1, electrostatic shields are usually made of a conducting material and not of a dielectric enclosure containing a dielectric.

As a result of this surprising finding, it is proposed according to the invention to arrange the electrostatic shield of an electrical apparatus in such a way that it is at least in part formed by a dielectric enclosure which contains water. The invention has different advantages, such as an easier design of the electrical apparatus, since a dielectric enclosure can be arranged even close to or in direct contact to conducting parts of the apparatus or between different parts of the apparatus which lie at different voltage levels Another advantage lies on the cost side, since the use of a dielectric material for the enclosure, which is preferrably a synthetic material like plastic, results usually in lower costs for the manufacturing and installation of the enclosure, since the design possibilities are much more varied compared to metal. Water itself is—in comparison—not costly at all.

In a preferred embodiment of the invention, the dielectric enclosure is part of a cooling water circuit. The use of water and especially purified water as a cooling liquid in electrical apparatuses operated at medium or high voltage level, i.e. at voltages above 1 kV, is quite common. As is described in WO2007/149023, it is known to use cooling conduits made of either metal, such as aluminum, or plastic. In case of plastic conduits it is according to WO2007/149023 necessary to provide separate electric field shielding means. When applying the invention to such a cooling water circuit already present in an electrical apparatus, the separate electric field shielding means can be omitted, thereby simplifying the overall design of the electrical apparatus and reducing its weight, its material costs and the effort for the manufacturing and for installation of the electrical apparatus.

In a further embodiment of the invention, the dielectric enclosure is connected with a first connection point to a first voltage level. As described above, a dielectric enclosure has by its nature the advantage of having a low conductivity so that it can be placed nearby or directly in contact to live parts of the electrical apparatus. Since the dielectric enclosure is not conducting, it can even be connected with a second connection point to a second voltage level, different from the first voltage level, without any risk of short-circuiting. This is a clear advantage over the electrical shields known in the art which are made of conducting materials.

In an even further embodiment of the invention, the dielectric enclosure is arranged as a pipe. In case that a substantial surface area of the electrical apparatus needs to be covered by an electrostatic shield, several such pipes can be placed in parallel to each other. If the pipes are at the same time part of a cooling water circuit, the water in the parallel pipes can be flowing into different directions, i.e. a part of the parallel pipes can contain so called incoming water and another part can contain outgoing water, where the incoming water is the fresh water at a lower temperature flowing into the electrical apparatus and the outgoing water is the water which has been heated up by the electrical apparatus and which is flowing out of the electrical apparatus.

Other features and advantages of the present invention will become more apparent to a person skilled in the art from the following detailed description of a particular embodiment of the invention in conjunction with the appended drawings, in which:

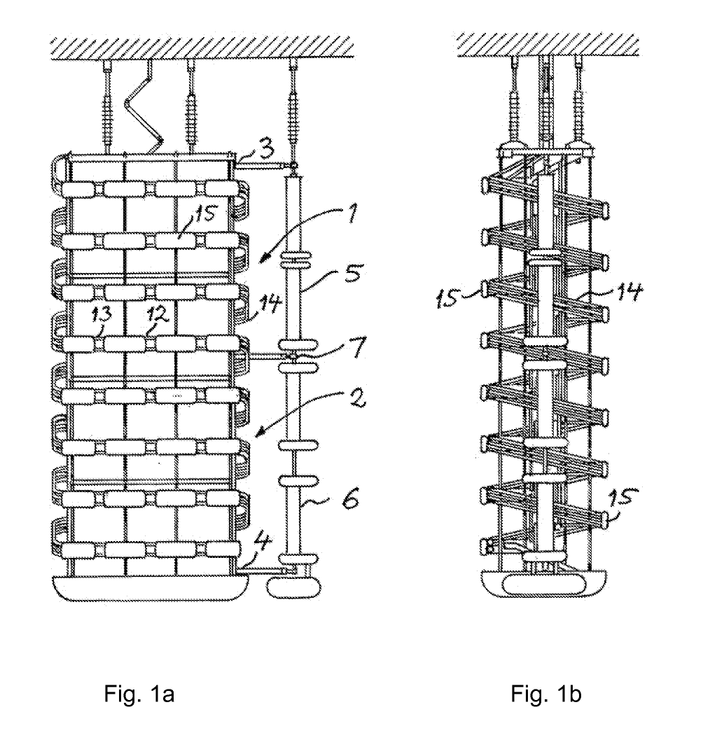

FIG. 1a shows a power converter valve stack known from the art in a first side view,

FIG. 1b shows the power converter valve stack of FIG. 1a in a second side view

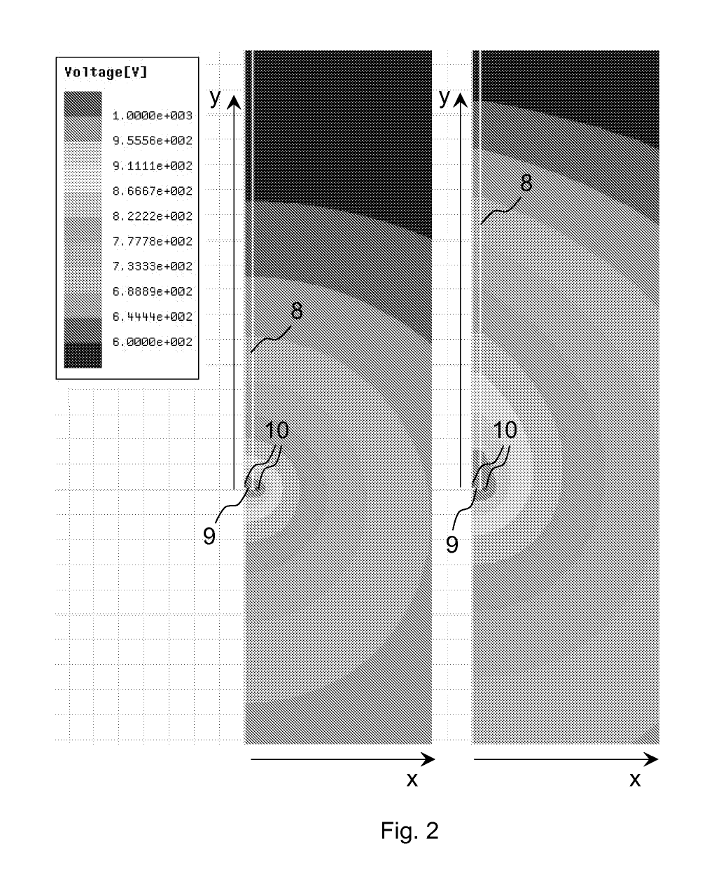

FIG. 2 shows the voltage distribution in a pipe and in its surrounding air-filled area with and without water in the pipe,

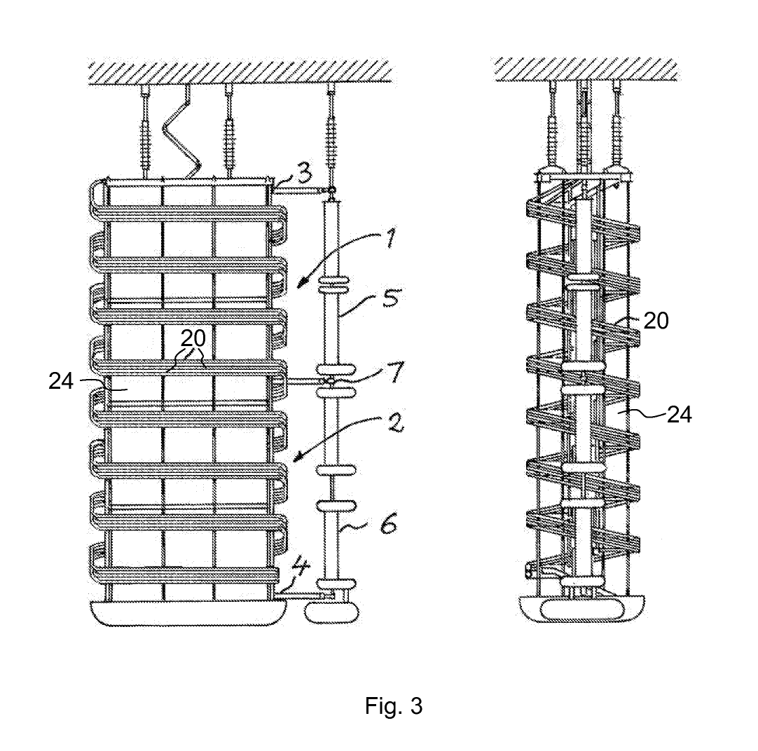

FIG. 3 shows the power converter valve stack of FIGS. 1a and 1b with an electrostatic shield according to the invention,

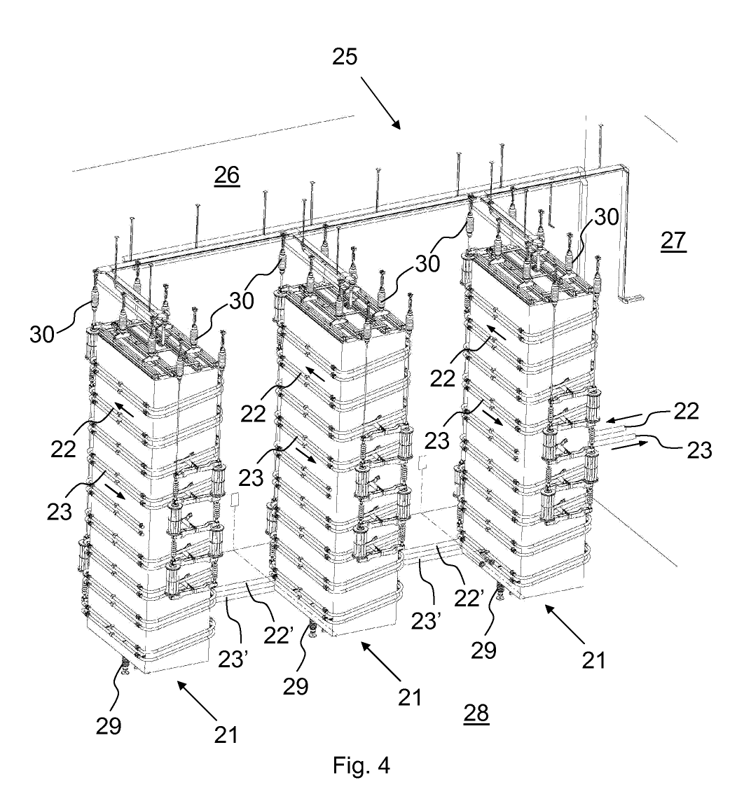

FIG. 4 shows a power converter with three valve stacks, each having an electrostatic shield according to the invention.

FIG. 1a illustrates a so called long side and FIG. 1b a so called short side of a power converter valve stack, as known from WO2007/149023A1. The power converter valve stack shown here comprises a series connection of two converter valves 1, 2, having power semiconductor devices, comprising for example thyristors or IGBTs, connected in series and arranged in superimposed layers within the converter valves 1 and 2. The two valves 1, 2 are arranged on top of each other in a column which has a substantially rectangular cross-section. One end 3 of the column is adapted to be connected to a high voltage potential, whereas the other end 4 is adapted to be connected to a low voltage potential on a DC-side of an AC/DC power converter. The voltage between the two ends 3, 4 is at a high voltage level, i.e. above 50 kV, and may well be in the order of 400 kV. In other embodiments having four or even eight converter valves in series connection and on top of each other, the voltage lies even in the order of 800 kV to 1200 kV. Current values normally are in the order of 500 A to 5 kA. Surge arresters 5, 6 are connected in parallel with each converter valve 1, 2 for protecting the corresponding converter valve against over-voltages. An AC-system is intended to be connected to the midpoint 7 between the converter valves 1 and 2.

This power converter valve stack may together with two similar such valve stacks form a three-phase AC/DC power converter having a so-called 6-pulse bridge configuration, or together with altogether six such valve stacks, a 12-pulse bridge can be formed. However, it is also possible that this power converter valve stack alone includes all the converter valves of a converter which is then connected to a one-phase AC-system.

The known power converter valve stack of FIGS. 1a and 1b has means for cooling the power semiconductor devices, which dissipate a lot of heat energy during their operation due to the high powers transmitted through a valve stack of this type. The cooling means comprise cooling blocks of for instance aluminum arranged in contact with the power semiconductor devices. These cooling blocks are cooled by cooling water flowing through a cooling water circuit, where the cooling water passes through the cooling blocks in pipes 12 extending in a loop along the current path in the converter valves 1, 2 in a serpentine around the valve stack as appears from FIGS. 1a and 1b. The cooling water inside the pipes 12 is circulated in order to transfer the heat away from the cooling blocks and thereby from the power semiconductor devices. By letting the cooling water follow the current path, an uneven distribution of voltage across the different thyristors is reduced to a minimum.

The pipes 12 are at the long sides of the valve stack made of an electrically insulating or dielectric material 13, such as plastic, and on the short sides, the pipes 12 are made of metal 14, such as aluminum or stainless steel. The partial use of a dielectric material is necessary in order to provide electric insulation between the cooling blocks and the pipes 12, since different cooling blocks are exposed to different voltage levels, depending on the relative position of their corresponding power semiconductor devices between the ends 3 and 4 inside of the column of the valve stack. If the pipes 12 were made completely out of metal, an undesired electric current would flow inside. Since no physical contact between the cooling blocks and the pipes 12 is made on the short sides of the valve stack, the pipes 12 can be made of metal 14 there.

Means for shielding the surrounding of the valve stack from the electric field generated by the valve stack need to be arranged around the valve stack outside the layers of power semiconductor devices, and this is achieved by arranging electrostatic screens 15 in the form of plates made of metal, for instance aluminum, on the outside of the pipes 12 in those areas where the pipes 12 are made of the dielectric material 13, i.e. on the long sides of the valve stack.

On the short sides of the valve stack, where the pipes 12 are made of metal, the pipes 12 themselves function as an electrostatic shield, in particular since three pipes 12 are arranged above each other, thereby forming a screen. As is stated in WO2007/149023, the pipes 12 are made of metal whereever possible in order to reduce the number of additional electrostatic screens.

The inventors have now found out that even those parts of the pipes which are made of a dielectric material can function as an electrostatic shield in a sufficient manner, provided that the pipes contain water.

FIG. 2 shows simulation results of the voltage distribution in a pipe 8 and in its surrounding air-filled area. The pipe 8 is depicted with a bright line. In the graphics to the right, the pipe 8 is filled with purified water, and in the graphics to the left, only air is inside the pipe 8. As is illustrated by two dots 10, a voltage above 1 kV is applied to the inside as well as to the outside of the pipe 8 close to one end 9 of the pipe. In the case of the water-filled pipe, the voltage level drops in a considerably longer distance from the end 9 of the pipe to a level below 600 V compared to the air-filled pipe. This is true in the direction x, perpendicular to the pipe 8, as well as in the direction y, alongside the pipe 8. Further, the almost regular rings of equal voltage level which appear in and around the air-filled pipe to the left are transformed into egg-shaped loops by the water-filled pipe to the right. An explanation for this effect is the relatively high permittivity of water compared to other dielectric materials.

Apart from the simulation, tests were performed at higher voltage levels which proved what can be expected, that the simulation results obtained for 1 kV can be extrapolated to several hundred kV and above. It was further proved that the arrangement of pipes containing purified water along the outside of an electrical apparatus clearly increases the dielectric strength of its surrounding air against both switching and lightning overvoltages.

FIG. 3 shows how the invention is advantageously applied to the power converter valve stack of FIG. 1, where the same components are marked with the same reference signs. Apart from this or other embodiments of power converter valve stacks, the invention may also be applied to other types of electrical apparatuses, especially to those which are operated at medium or high voltage level, such as motors, generators, power transformers, reactor inductors or electrical switchgear. As is illustrated in FIG. 3, all metallic electrostatic screens 15 are omitted, thereby considerably decreasing the weight, material and installation costs of the valve stack. All pipes 20 which surround the column 24 of the valve stack and which belong to the cooling water circuit of the means for cooling the power semiconductor devices are made of plastic. The parallel arrangement of three pipes 20 above one another for each round of the serpentines creates electrostatic shields both at the long and at the short sides of the valve stack which attenuate the electric field created by the valve stack in a sufficient manner. The pipes 20 thereby perform two functions at the same time: cooling and electrostatic shielding.

In FIG. 4, three identical valve stacks 21 are arranged in a converter hall 25, where the converter hall 25 has four side walls, with two side walls 26 and 27 being shown, as well as a floor 28 and a ceiling. The three valve stacks 21 are electrically connected to each other so as to form an AC/DC power converter. Apart from the electric coupling, the cooling water circuits of the three valve stacks 21 are coupled as well to each other, as can be seen from the interconnections 22′ and 23′. The valve stacks 21 differ from the valve stack of FIG. 3 mainly in that instead of three pipes 20, only two pipes 22 and 23 are arranged in parallel and above each other. Pipe 22 contains the inflowing water, which is pumped through the side wall 27 into the cooling water circuit and pipe 23 contains the outflowing water. The cooling water may preferrably be deionized water in order to reduce unwanted current flows inside the water and thereby unwanted power losses. But it is also possible to use ionized water, when losses are of no problem or can be accounted for by special measures.

As is seen in FIG. 4, the three valve stacks 21 are all hanging, each via eight insulators 30, from the ceiling. Only a seismic damping element 29 is arranged between each valve stack 21 and the ground floor 28, which reduces movements of the respective valve stack 21 in case of an earth quake. The reduced weight by avoiding any electrostatic shields made of metal is therefor a clear advantage.

In the examples shown in FIGS. 3 and 4, the dielectric enclosures containing water are embodied as pipes extending in several serpentine loops around the column of the corresponding valve stack, so that the sides of the column are partly covered. In addition to that, the pipes could as well cover parts of the bottom and/or top of the column. In general, any possible geometrical form and shape of a dielectric enclosure can be used, which is from a manufacturing standpoint no problem since synthetic materials, such as plastic, can easily be given any shape via known fabrication methods.

1.-10. (canceled)

11. A power converter valve stack comprising an electrostatic shield to reduce the electrical field strength outside of the apparatus, the electrostatic shield is at least in part formed by a dielectric enclosure, which dielectric enclosure is part of a cooling water circuit, wherein the dielectric enclosure contains deionized water, is plastic and arranged as a pipe.

12. The power converter valve stack according to claim 11, where the power converter valve stack is configured to be operated at voltages above 1 kV.

13. The power converter valve stack according to claim 11, where the dielectric enclosure is configured to be connected with a first connection point to a first voltage level.

14. The power converter valve stack according to claim 13, where the dielectric enclosure is configured to be connected with a second connection point to a second voltage level.

15. The power converter valve stack according to claim 11, wherein said pipe is a pipe among pipes extending in a serpentine loop around the power converter valve stack.

16. The power converter valve stack according to claim 11, wherein the dielectric enclosure comprises a parallel arrangement of two or three pipes above one another.

17. The power converter valve stack according to claim 11, where the power converter valve stack is configured to be operated at voltages above 50 kV.

18. The power converter valve stack according to claim 12, where the dielectric enclosure is configured to be connected with a first connection point to a first voltage level.

19. The power converter valve stack according to claim 12, wherein said pipe is a pipe among pipes extending in a serpentine loop around the power converter valve stack.

20. The power converter valve stack according to claim 13, wherein said pipe is a pipe among pipes extending in a serpentine loop around the power converter valve stack.

21. The power converter valve stack according to claim 14, wherein said pipe is a pipe among pipes extending in a serpentine loop around the power converter valve stack.

22. The power converter valve stack according to claim 12, wherein the dielectric enclosure comprises a parallel arrangement of two or three pipes above one another.

23. The power converter valve stack according to claim 13, wherein the dielectric enclosure comprises a parallel arrangement of two or three pipes above one another.

24. The power converter valve stack according to claim 14, wherein the dielectric enclosure comprises a parallel arrangement of two or three pipes above one another.

25. The power converter valve stack according to claim 15, wherein the dielectric enclosure comprises a parallel arrangement of two or three pipes above one another.

26. The power converter valve stack according to claim 12, where the power converter valve stack is configured to be operated at voltages above 50 kV.

27. The power converter valve stack according to claim 13, where the power converter valve stack is configured to be operated at voltages above 50 kV.

28. The power converter valve stack according to claim 14, where the power converter valve stack is configured to be operated at voltages above 50 kV.

29. The power converter valve stack according to claim 15, where the power converter valve stack is configured to be operated at voltages above 50 kV.

30. The power converter valve stack according to claim 16, where the power converter valve stack is configured to be operated at voltages above 50 kV.
